(19) United States
(12) Patent Application Publication
(10) Pub. No.: US 2007/0051629 A1
(43) Pub. Date: Mar. 8, 2007

(54) Poly(amino saccharide) wall coating for electrophoretic separations in capillaries and microchannels

(76) Inventor: Vladislav - Dolnik, Mountain View, CA (US)

Correspondence Address: VLADISLAV DOLNIK, 409 KENT DRIVE, MOUNTAIN VIEW, CA, 94043, US

(21) Appl. No.: 11/162,403

(22) Filed: Sep. 8, 2005

(51) Int. Cl. G01N 27/00

(52) U.S. Cl. 204/601

(57) ABSTRACT

The present invention describes a method of preparation of a charged wall coating made of thermally immobilized cationic polysaccharides. The coating enables stable electroosmotic flow to be generated.

### TECHNICAL FIELD

The present invention generally relates to surface treatment, films and coatings, and more particularly, coatings for chromatography and electrophoresis in capillaries and microchannels. Specifically, the invention is directed to wall coatings in capillary electrophoresis to generate a stable reversed electroosmotic flow.

### BACKGROUND ART

Capillary electrophoresis has achieved a remarkable development from its introduction in the early 1980s. This technique miniaturizes the electrophoretic process and presents remarkable advantages over traditional slab gel electrophoretic techniques. Most of materials used to prepare separation channels or capillaries for capillary electrophoresis (CE) contain surface ionizable groups that are responsible for so-called electrokinetic potential or ζ-potential. This potential is a cause of electroosmotic flow (EOF). Typically EOF is to be eliminated to improve separation efficiency of capillary electrophoresis. Nevertheless, in some applications, EOF is welcomed. E.g., in CE separation of proteins at low pH followed by mass spectrometry (MS), a positive wall coating generates EOF that pumps separated proteins out of the separation channel or capillary to mass spectrometer. Although separation efficiency is typically lower than in separations with eliminated EOF a direct coupling CE to MS brings some advantages.

Various wall coatings have been proposed to reverse EOF. Frequently a dynamic wall coating is formed where an additive (cationic detergent such as cetyltrimethylammonium bromide, polycations such, putrescine, spermidine, or spermine, or a cationic polymer such as polyarginine or Polybrene) is added to the background electrolyte (Horvath, J. and Dolnik, V., Electrophoresis 2001, 22, 644-655.). A polysaccharide chitosan was also used as a dynamic coating (Yao, Y. J. and Li, S. F. Y., J. Chromatogr. A 1994, 663, 97-104). In a capillary it adsorbs on the capillary wall and brings a positive charge to the capillary surface. Dynamic wall coatings are popular because of the simplicity of their preparation. Nevertheless their lifetime may be rather short. Static coatings, on the contrary, are prepared by rather more laborious method; however, they provide more reproducible EOF. Poly(2-aminoethyl methacrylate hydrochloride) (Liu, Q. C., et al., J. Liq. Chromatogr. 1997, 20, 707-718), copolymer of vinylpyrrolidone and vinylimidazole (Xu, R. J. et al., J. Chromatogr. A, 1996, 730, 289-295.), and polyvinylamine (Chiari, M. et al., J. Chromatogr. A 1999, 836, 81-91) were used to make a coating generating reversed electroosmotic flow.

One of the methods to attach a polymer to a capillary or channel wall permanently is thermal immobilization of the polymer on the capillary wall. Schomburg and Gilges proposed a poly(vinyl alcohol) (PVA) coating fixed thermally to the wall by heating the capillary at 140° C. They assumed that formation of a permanent PVA coating is based on PVA becoming water insoluble by thermal treatment and expected PVA to form semicrystalline highly associated structures that are not covalently bound to fused silica capillary. PVA molecules become more strongly associated by hydrogen bridges and water molecules cannot penetrate microcrystalline domains. The authors expressed their opinion that this is a unique property of PVA (Schomburg, G., Gilges, M., U.S. Pat. No. 5,502,169). Thermal immobilization was also applied to hydroxyethyl cellulose (HEC) and hydroxypropyl cellulose (HPC) (Shen, Y. and Smith, R. D., J. Microcol. Sep. 2000; 12, 135-141). The authors found that the wall coating is stable if the silica capillaries are heated at 140° C. for 20 min rather than just being dried at room temperature for 4 days. From this observation they concluded that a chemical reaction must have occurred between coated cellulose derivatives and fused silica capillary inner wall.

Chitosan is chemically 1-4-β-linked polymer of D-glucosamine (Yalpani, M. Polysaccharides. Amsterdam, Elsevier; 1988.). It is typically prepared by deacetylation of chitin. It is soluble in aqueous acidic solutions.

Diethylaminoethyl-dextran (DEAE-dextran) is a polycationic derivative of dextran and is produced by reacting diethylaminoethyl chloride with Dextran. The degree of the chemical substitution corresponds to approximately one DEAE-substituent per three glucose units. The weight-average molecular weight of DEAE-dextran is approximately 500 000. DEAE-dextran has two types of substituents; a single tertiary DEAE-group with pKₐ 9.5 and a “tandem” group (pKₐ 5.7) with a quaternary amine group (pKₐ 14) (http://www.dextran.dk/deae_index.htm).

### SUMMARY OF THE INVENTION

The present invention is useful as a capillary coating that generates reversed electroosmotic flow, especially for CE of proteins followed by mass spectrometry. The present invention consists in a method of preparing the above coating and a method how the coated capillary is used.

### BRIEF DESCRIPTION OF THE DRAWINGS

FIG. 1 shows dependence of electroosmotic mobility of chitosan coating on pH of the background electrolyte (BGE) at pH 3.1: 100 mM β-alanine, citric acid; pH 4.1; 100 mM γ-aminobutyric acid, glutamic acid; pH 6.3; 100 mM BisTris-MES; pH 7.9; 100 mM Tris, HEPES, pH 8.1.

FIG. 2 shows the dependence of electroosmotic mobility of chitosan coating on concentration of acetic acid used as a background electrolyte.

FIG. 3 shows the effect of concentration of additives on electroosmotic mobility of chitosan coating in 5 mM acetic acid. ▪—methanol; ▴—isopropylalcohol; ●—dimethyl sulfoxide.

FIG. 4 is electropherogram of a model protein mixture in chitosan-coated capillary. Fused silica capillary: I(total)=335 mm, I (effective)=250 mm, ID=75 μm, OD=360 μm. Background electrolyte: 250 mM pivalic acid. Voltage: −20 kV. Detection at 214 nm. Injection: 5 s at 50 mbar. Sample: 0.7 g/L cytochrome c, lysozyme, trypsinogen, α-lactalbumin.

### BEST MODE FOR CARRYING OUT THE INVENTION

### EXAMPLE 1

Preparation of Thermally Immobilized Chitosan Wall Coating

3 m piece of fused silica capillary (75 μm ID, 360 μm OD) was flushed with 0.1 mL thionyl chloride at pressure of 200 psi to cleanse the inner surface of the capillary. Then the capillary was filled with a solution of chitosan by pressure of 1000 psi. The solution of chitosan was prepared as 10 g/L chitosan, (medium molecular weight, Aldrich) in 1% acetic acid, filtered at 500 psi through 0.20 μm nylon filter. The solution of chitosan was left to flow through the capillary for 20 minutes. Then the capillary was emptied by flushing it with nitrogen through a 0.2 μm nylon syringe filter at 1000 psi. When empty, the capillary was dried by additional nitrogen flow at 100 psi. After 20 min, the nitrogen flow was reduced to 20 psi and the capillary was placed in an oven heated to 140° C. for 30 minutes. After 30 minutes the capillary was cooled to room temperature and the nitrogen flow was stopped. The process was sometime repeated (without the thionyl chloride treatment) to provide multiple-layer capillary coating.

Similarly other poly(amino saccharides) can be used to make a cationic hydrophilic wall coating including DEAE-dextran or heparin, to name a few. Then the prepared poly(amino saccharide) film may have other applications including weak cationic stationary phase for chromatography or as a layer for attachment of nucleic acid or proteins in microarrays.

### EXAMPLE 2

Electroosmotic Mobility of Chitosan Wall Coating and its Dependence on pH and Electrolyte Concentration

Electroosmotic mobility (PEEO) of the prepared wall coating was measured in a 335 mm long capillary with effective length of 250 mm using 100 mM equimolar solution of β-alanine and citric acid (pH 3.1), γ-aminobutyric acid and glutamic acid (pH 4.1), 2,2-bis(hydroxymethyl)-2,2′,2″-nitrilotriethanol (BisTris) and N-morpholinoethane sulfonic acid (MES) (pH 6.3), tris(hydroxymethyl)aminomethane (Tris) and N-(2-hydroxyethyl)piperazine-N′-(2-ethanesulfonic acid) (HEPES) (pH 7.9) as a background electrolyte. 1 g/L hydroxyethyl methacrylate was used as a neutral marker. First the neutral marker was injected as a 2 s pulse at 50 mbar and was moved forward by pumping background electrolyte for 35 s at 50 mbar into capillary. Then another 2-s pulse of the neutral marker was injected at 50 mbar and moved forward by pumping background electrolyte for 35 s at 50 mbar into the capillary. Voltage of −10 kV was applied for 180 s and then a 3^{rd} pulse of the neutral marker (2 s at 50 mbar) was introduced into the capillary. Eventually all three bands of the neutral marker were pumped through the detector while measuring absorption at 214 nm. Migration times of the obtained peaks were used to calculate electroosmotic mobility (Williams, B. A. and Vigh, G., Anal. Chem. 1997, 69, 4445-4451). Alternatively, a migration time of the neutral marker hydroxyethyl methacrylate was measured in a single CZE run and this value was also used to calculate electroosmotic mobility.

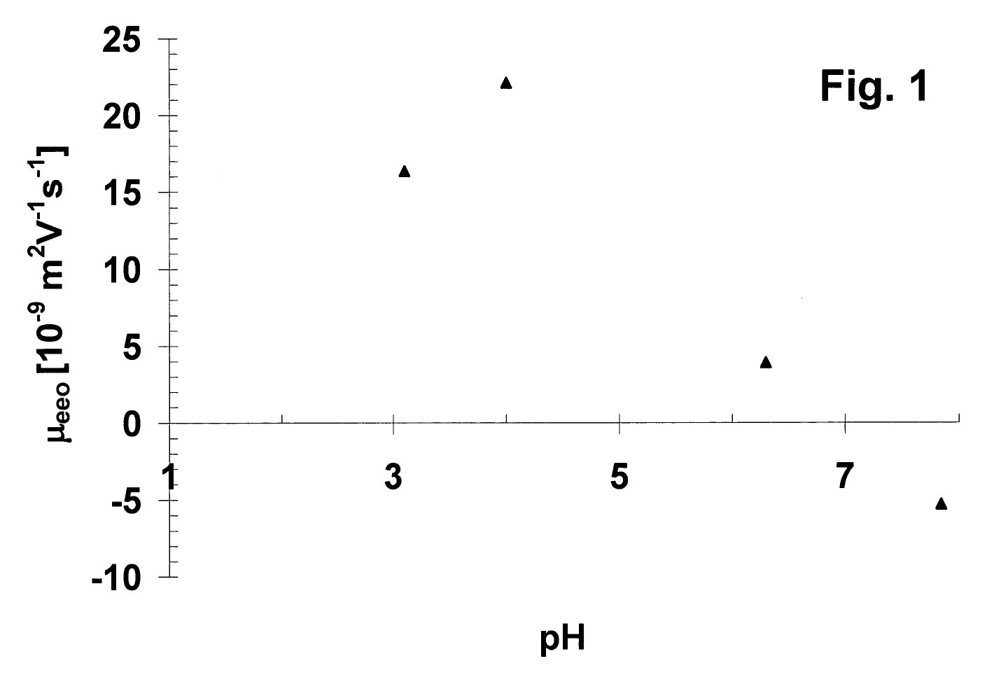

The electroosmotic mobility increases with decreasing pH (FIG. 1). This phenomenon reflects the increased ionization of amino groups of the used poly(amino saccharide) but simultaneously it may also mean hypothetical a lowered ionization of carboxylic groups that are potentially present in the molecule of the immobilized poly(amino saccharide). Nevertheless, more factors affect electroosmotic mobility of the wall coating such as ionic strength of the background electrolyte and adsorption of ions (namely anions) of the used background electrolyte on the wall, etc. That is probably why the electroosmotic mobility of the chitosan wall coating at pH 3.1 (BGE 100 mM β-alanine, citric acid) is surprisingly lower than at pH 4.1 (BGE 100 mM γ-aminobutyric acid, glutamic acid). β-alanine (pKₐ 3.55) is at pH 3.1 ionized to higher degree than γ-aminobutyric acid (pKₐ 4.0) at pH 4.1 and 100 mM β-alanine, citric acid has higher ionic strength than BGE containing 100 mM γ-aminobutyric acid, glutamic acid.

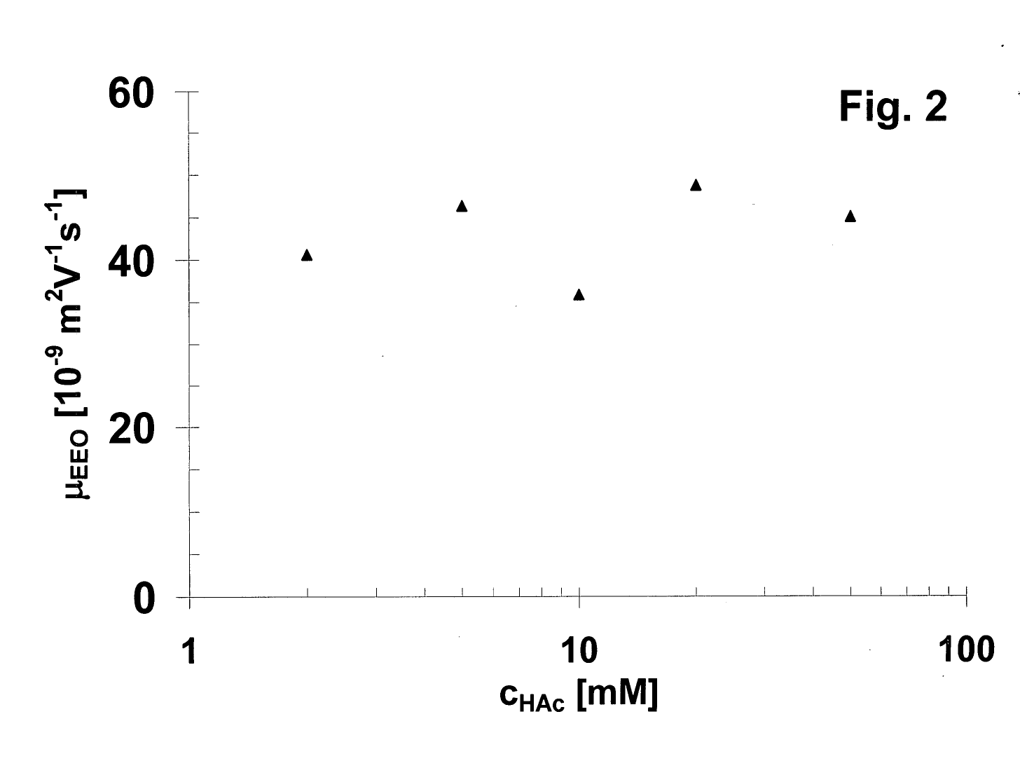

For mass spectrometry of the separated proteins, it is always advantageous to use a volatile background electrolyte. Presence of a cation in the background electrolyte may reduce ionization of proteins and therefore diluted solution of volatile acids may be a used as background electrolyte in these separations. Diluted aqueous solution of acetic acid (pKₐ 4.75) is a prospective background electrolyte for CE-MS of proteins. Electroosmotic mobility of the chitosan wall coating does not change significantly if the concentration of acetic acid in BGE varies in the range of 2-50 mM (FIG. 2).

### EXAMPLE 3

Effect of Electrolyte Additives on Electroosmotic Mobility

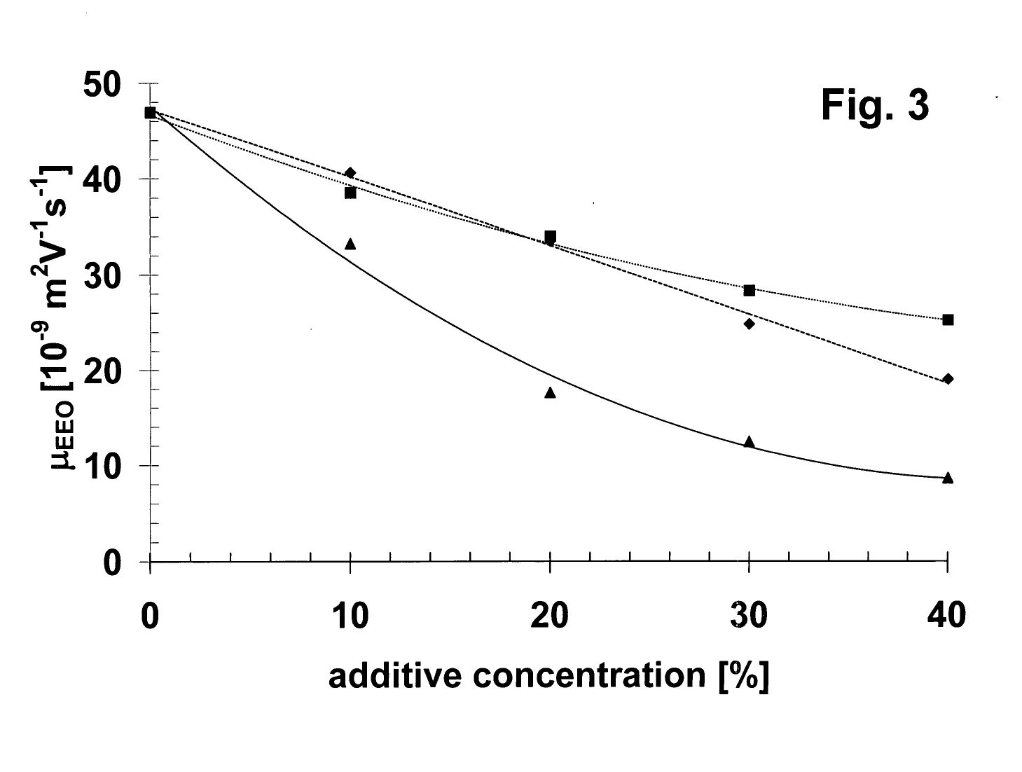

It may be advantageous to ad some additives with low boiling point (non-aqueous solvents) to background electrolyte to speed up evaporation of BGE during mass spectrometry. The electroosmotic mobility of chitosan coating decreases with increased concentration of added non-aqueous solvent (FIG. 3). Whereas addition of methanol causes relatively low decrease of electroosmotic mobility, the reduction of PEEO of chitosan wall coating is more significant with addition of isopropyl alcohol. Dimethyl sulfoxide reduces PEEO in an extent similar to methanol.

### EXAMPLE 4

Capillary Zone Electrophoresis of Model Protein Mixture

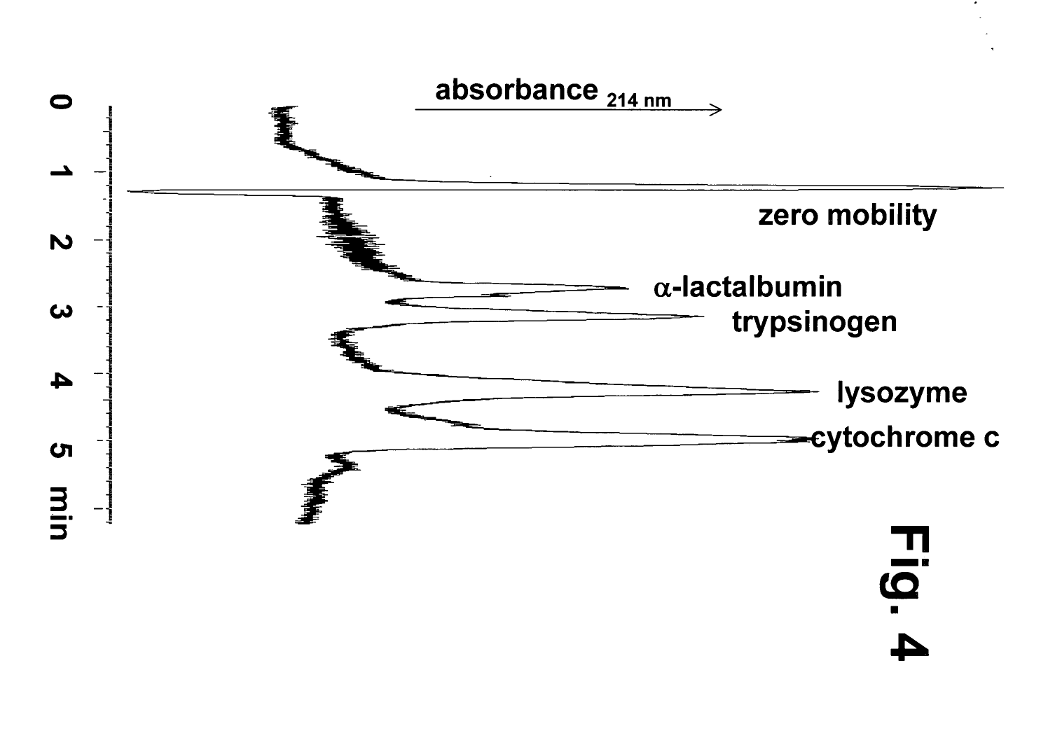

Quality of the prepared chitosan wall coating was tested by CZE of model proteins in the chitosan-coated fused silica capillary. The total length of the capillary was 335 mm; the effective length of the capillary was 250 mm. The capillary had ID 75 μm and OD 360 μm. A diluted solution of a volatile acid, 250 mM pivalic acid, was used as BGE. During the separation, a constant voltage of −20 kV was applied. The sample containing 0.70 g/L cytochrome c, lysozyme, trypsinogen, and α-lactalbumin in water was injected hydrodynamically by pressure of 50 mbar for 5 s. The peaks were detected by measuring UV absorbance at 214 nm. Strong electroosmotic flow pumped analytes towards the destination electrode. Although the proteins migrated electrophoretically towards cathode the generated anodic EOF was stronger and pushed the proteins in the opposite direction. All four model proteins were separated in less than 6 minutes (FIG. 4).

### EXAMPLE 5

Preparation of Thermally Immobilized DEAE Dextran Wall Coating

3 m piece of fused silica capillary 75 μm ID, 360 μm OD was flushed with 0.25 mL thionyl chloride at the pressure of 200 psi to cleanse the inner surface of the capillary. Then the capillary was filled with a solution of DEAE-dextran by pressure of 500 psi. The solution of DEAE-dextran was prepared as 50 g/L DEAE-dextran (Mr 500,000) in deionized water, and filtered at 500 psi through a 0.45 μm nylon filter. The solution of DEAE-dextran was left to flow through the capillary for 30 minutes when about 0.1 mL of DEAE-dextran solution got through. Then the capillary was emptied by nitrogen at 500 psi and dried by flowing nitrogen at 100 psi for 30 min. After dried, the capillary was placed in an oven heated to 140° C. for 30 minutes with the nitrogen flow reduced to 20 psi. After 30 minutes the capillary was taken out and the nitrogen flow was stopped. The process was sometimes repeated (without the thionyl chloride treatment) providing multiple layer capillary coating.

References Cited

U.S. Patent Documents

Hjertén, S., Coating for electrophoresis tube. U.S. Pat. No. 4,680,201, 1987.

Novotny, M. V.; Cobb, K. A., Dolnik, V., Suppression of electroosmosis with hydrolytically stable coatings. U.S. Pat. No. 5,143,753, 1991.

Schomburg, G., Gilges, M., Deactivation of the inner surfaces of capillaries. U.S. Pat. No. 5,502,169, 1996.

Other References:

Yao, Y. J. and Li, S. F. Y., Capillary Zone Electrophoresis of Basic Proteins with Chitosan as a Capillary Modifier. J. Chromatogr. A, 1994, 663, 97-104.

Liu, Q. C.; Lin, F. M., and Hartwick, R. A. Free Solution Capillary Electrophoretic Separation of Basic-Proteins and Drugs Using Cationic Polymer-Coated Capillaries. J. Liq. Chromatogr. 1997, 20, 707-718.

Xu, R. J., Vidal-Madjar, C., Sebille, B., and Diez-Masa, J. C., Separation of basic proteins by capillary zone electrophoresis with coatings of a copolymer of vinylpyrrolidone and vinylimidazole. J. Chromatogr. A, 1996, 730, 289-295.

Chiari, M.; Ceriotti, L.; Crini, G., and Morcellet, M., Poly(vinylamine)-coated capillaries with reversed electroosmotic flow for the separation of organic anions. J. Chromatogr. A 1999, 836, 81-91.

Horvath, J. and Dolnik, V., Polymer wall coatings for capillary electrophoresis. Electrophoresis 2001, 22, 644-655.

Shen, Y. and Smith, R. D., High-resolution capillary isoelectric focusing of proteins using highly hydrophilic-substituted cellulose-coated capillaries. J. MicrocoL Sep. 2000, 12, 135-141.

Yalpani, M. Polysaccharides. Syntheses, Modifications and Structure/Property Relations. Amsterdam-Oxford-New York-Tokyo: Elsevier; 1988.

What is claimed is:

1. A capillary system for chromatographic or electrophoretic separation of molecules, the system comprising:
a separation column realized as a microchannel in a body or as a capillary, said separation column made of an electrically insulating material, said material comprising fused silica, glass, poly(methyl methacrylate), polycarbonate, poly(tetrafluoroethylene), cyclic polyolephines;
a polymeric coating attached permanently to the interior surface of said separation column.

2. The coating of claim 1, wherein said coating is made of one or more permanent layers.

3. The coating of claim 2, wherein said coating comprises at least one layer made of polysaccharide having ionizable groups.

4. The coating of claim 3, wherein said polysaccharide has average weight molecular mass in the range of 10⁴ and 3×10⁶.

5. The coating of claim 4, wherein said polysaccharide is poly(amino saccharide).

6. The coating of claim 5 wherein said poly(amino saccharide) is chitosan or DEAE-dextran.

7. The coating of claim 6, wherein said poly(amino saccharide) is attached to the wall of said separation channel be thermal immobilization.

8. The coating of claim 7, wherein said thermal immobilization is performed by heating the separation channel in a protective atmosphere or under vacuum to temperature between 100 and 160° C. for 5-600 minutes.

9. The coating of claim 8, wherein said protective atmosphere is dry nitrogen (at least 99.9%), dry helium (at least 99.9%), or dry argon (at least 99.9%).

10. The coating of claim 8 wherein said vacuum is pressure below 1 torr.

11. The coating of claim 8 wherein said thermal immobilization is performed by heating the separation channel in a protective atmosphere or under vacuum to temperature between 100 and 145° C. for 20-60 minutes.

12. The coating of claim 4, wherein said polysaccharide is an acid polysaccharide containing ionizable acidic groups.

13. The coating of claim 12, wherein said acid polysaccharide is hyaluronic acid, chondroitin sulfate, heparin, gelan, karaya gum, xantahan gum, tragacanth gum, or arabic gum.

14. The coating of claim 12, wherein said acid polysaccharide contains ionizable sulfonic groups.

15. The coating of claim 14, wherein said acid polysaccharide is heparin, carrrageenan, dermatan sulfate, keratan sulfate, heparan sulfate, dextran sulfate, or chondroitin sulfate.
